(19) United States
(12) Patent Application Publication
(10) Pub. No.: US 2011/0026882 A1
(43) Pub. Date: Feb. 3, 2011

(54) LENSED OPTICAL CONNECTOR WITH PASSIVE ALIGNMENT FEATURES

(75) Inventors: Russell A. Budd, Yorktown Heights, NY (US); Frank R. Libsch, Yorktown Heights, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 12/533,588

(22) Filed: Jul. 31, 2009

(51) Int. Cl. G02B 6/42; G02B 6/36; G02B 6/38

(52) U.S. Cl. 385/52; 385/93; 385/60

(57) ABSTRACT

A simply constructed and economical optical connector, wherein a fiber ribbon or waveguide ribbon cable incorporates a plurality of projecting fiber or waveguide ends adapted to engage into a guiding feature in a structure that incorporates an array of microlenses, upon said structure being aligned with and attached to a ferrule housing the ribbon cable. The guiding feature enables apertures in the ferrule within which the projecting fiber or waveguide ends are guides towards engagement with guiding feature in the microlens containing structure, to be formed or dimensioned with relaxed tolerances relative to the fiber or waveguide ends, thereby considerable reducing manufacturing costs for the ferrule.

### FIELD OF THE INVENTION

The present invention relates to a lens optical connector possessing passive alignment features, and more particularly pertains to a self-aligning optical interconnect structure for the connection of the fiber ends or optical wave guides to arrays of microlenses.

In the technological field of data processing and architecturally larger multi-core processing system arrangements there is an ever-increasing need for high speed optical interconnects with the utilization of optical fiber arrays.

With respect to the foregoing, it has become readily evident in the technology that the employment of optical waveguides will provide an efficient and economical method of managing the employment of large numbers of optical channels, wherein in particular, there is a present need for the provision of structurally simple, low cost waveguide connectorizations which are not bound to precise waveguide thickness controls. In that connection, the use of novel optical connectors employing optical flex sheets, i.e., comprising optical fiber ribbon cables or waveguide ribbon cables, which are interconnected in a simple and low cost manner, satisfies the need of future high performance computers which may contain literally thousands of optical channels. Such a multitude of optical channels may be employed with waveguide optical flex sheets consisting of polymer, which by way of example, may be either connected to the top or upper surface of a printed circuit board (PCB), embedded in the board, or installed as interconnect cables between such boards.

### The PRIOR ART

Kang, et al., U.S. Pat. No. 6,629,780 B2 discloses a high precision format multi-fiber connector which is adapted to provide for and maintain a higher degree of accuracy and low-precision loss over repeated connectorizations of the connector components. Although the connected structure discloses a solution to various problems that are encountered by fiber connectors, such as loss of accuracy, it does not incorporate any optical microlenses which are intended to be mated in a precise manner with an array of the optical fibers, and also fails to disclose the manner in which a stack of waveguides is aligned to another component in a precise mode.

Concerning Dautartas, et al., U.S. Pat. No. 6,442,306 B1 this publication discloses a self aligned fiber optic connector for N×M arrays of optical fibers, wherein the optical fibers of the array incorporate aligning structures such as ball lenses, which provide for a desired coupling or connectorization efficiency. However, in that instance, the disclosed connector structure is extremely complex in nature, and is not adapted to provide for the simple and economically inexpensive connection of an array of multiple microlenses with the ends of fiber optic strands extending from an optical flex or waveguide ribbon cable housed in a suitable ferrule.

### SUMMARY OF THE INVENTION

Pursuant to the present invention, there is accordingly provided a simply constructed and economical optical connector, wherein a fiber ribbon or waveguide ribbon cable incorporates a plurality of projecting fiber or waveguide ends adapted to engage into a guiding feature in a structure that incorporates an array of microlenses, upon said structure being aligned with and attached to a ferrule housing the ribbon cable. The guiding feature enables apertures in the ferrule within which the projecting fiber or waveguide ends are guided towards engagement with guiding feature in the microlens containing structure, to be formed or dimensioned with relaxed tolerances relative to the fiber or waveguide ends, thereby considerable reducing manufacturing costs for the ferrule.

Moreover, the waveguide ribbon cables, which may be essentially each flat in shape, may be stacked within the ferrule without the necessity for providing a precise thickness control, inasmuch as the desired alignment with the array of microlenses will be ensured by the provision of the guiding feature in the microlens-containing structure, into which the projecting contiguous ends of the stacked waveguides are inserted, and which optically communicate with respective therewith associated microlenses.

Accordingly, it is an object of the present invention to provide a novel and advantageous connector for fiber or waveguide cables with arrays of microlenses in a structure which incorporate passive guiding features ensuring an accurate optically aligned communication between these components.

A more specific object of the present invention resides in the provision of a ferrule housing the fiber or waveguide cables whereby the ends of the fibers or waveguides projecting towards the structure containing the microlenses are conveyed through apertures possessing relaxed tolerances relative to the cables so as to facilitate appreciable reductions in the manufacturing costs of the ferrule.

### BRIEF DESCRIPTION OF THE DRAWINGS

Reference may now be made to the following detailed description of preferred embodiments of the invention, taken in conjunction with the accompanying drawings, in which:

FIGS. 1A-1C illustrates, respectively, top sectional, side and front views of a ferrule housing a fiber ribbon cable with polished leading fiber ends pursuant to the prior art;

FIGS. 2A-2D illustrate, respectively, front, side, cross-sectional and enlarged fragmentary views of a microlens containing structure pursuant to the prior art;

FIGS. 3A-3D illustrate the ferrule with the prior art microlens containing structures of FIGS. 2A-2D aligned therewith in, respectively, front, side, cross-sectional and enlarged fragmentary views;

FIGS. 4A-4G illustrates, respectively, front, side, back, cross-sectional and enlarged fragmentary views of a first embodiment of a microlens containing structure with guide features pursuant to the invention;

FIGS. 5A-5D illustrate respectively front, side, cross-sectional and enlarged fragmentary views of a embodiment of a ferrule aligned with the structure shown in FIGS. 4A-4E pursuant to the invention;

FIGS. 6A-6E illustrate respectively front, side, back, cross-sectional and enlarged fragmentary views of a modified embodiment of a microlens containing structure pursuant to the invention; and

FIGS. 7A-7D illustrate, respectively, front, side, cross-sectional and enlarged fragmentary views of a ferrule aligned with the structure shown in FIGS. 6A-6E pursuant to the present invention.

### DETAILED DESCRIPTION

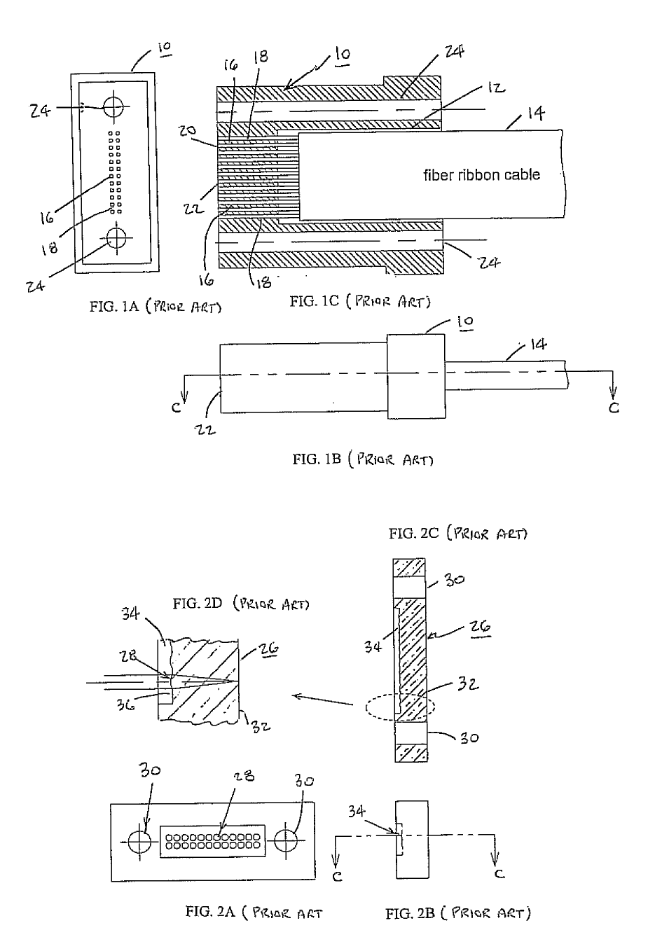

Referring now in detail to the drawings, in particular the prior art embodiment representation of FIGS. 1A-1C, there is disclosed a simple ferrule 10 having an aperture 12 for the receipt of a fiber ribbon cable 14. The cable 14 includes a 3-dimensional array of optical fibers 16 extending forwardly from the cable 14 through small holes 18 in the ferrule communicating with aperture 12, so as to terminate in polished fiber ends 20 coextensive with the front surface 22 of the ferrule. The ferrule holes 18 form close-fitting guide holes for the respective optical fibers 16 and whereby the polished front ends of the fibers are intended to be aligned with optical lenses as detailed hereinbelow. The ferrule also contains at least two guide holes 24 adapted to be aligned with similar guide holes in a microlens-containing member, and for receiving suitable connectors (not shown.).

Concerning the foregoing, the holes 18 which guide the respective optical fibers 16 towards the leading end of the ferrule, are manufactured so as to provide a highly-accurate guidance for the leading or polished front ends 20 of the optical fibers 16 which are coplanar with the surface 22 on the ferrule adapted to contact the housing 26 for an arrays of microlenses 28. This entails a relatively expensive procedure in the manufacture of the accurately sized and spaced array of holes 18 for receiving and guiding the leading ends of the optical fibers emanating from the fiber ribbon cable which extends into the ferrule. As a result, the manufacture of the ferrule 10 is relatively expensive in nature inasmuch as it necessitates the use of sophisticated tooling and manufacturing techniques which will ensure the proper alignment of the holes 18 through which the optical fibers 16 are guided into optical alignment with the array of microlenses 28 with which they are to be communicating.

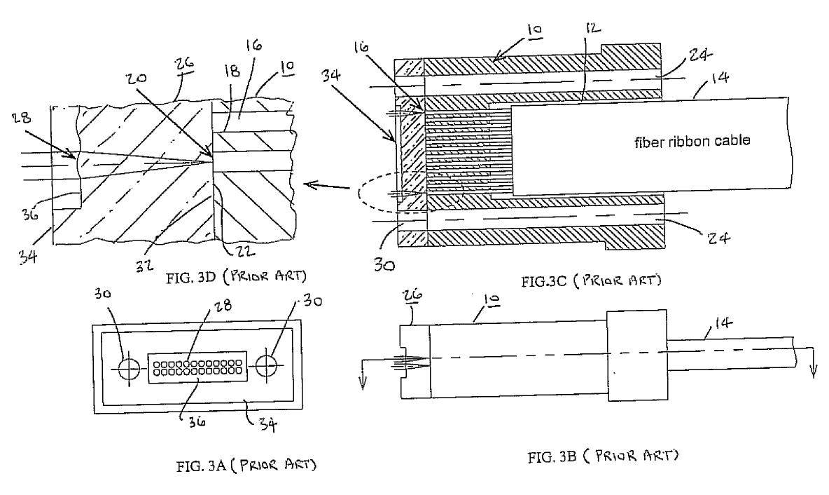

In particular, as illustrated in FIGS. 2A-2D of the drawings, there is illustrated the prior art housing structure 26 of essentially a configuration, the surface towards the ferrule of which conforms to the front end surface 22 of the ferrule. Within the housing structure there is incorporated an array of the microlenses 28 as described hereinbelow there are also provided alignment holes 30 which are in conformance with the alignment holes 24 of the ferrule 10 so as to enable the housing structure to be accurately attached thereto by means of suitable fasteners (not shown).

In this instance, the prior art housing 26 incorporating the microlens array 28 includes a polished surface 32 which is in accurate contact with the end surface 22 of the ferrule, and whereby the distal or opposite surface 34 of the housing 26 includes a recessed surface portion 36 which is configured to provide for the microlens array 28 which are in optical alignment with the respective leading or front ends 20 of the optical fibers 16. The material of the housing 26 which contains the array of microlenses is optically transmissive and is preferably constituted of a transparent plastic or a glass material, as is well known in the art.

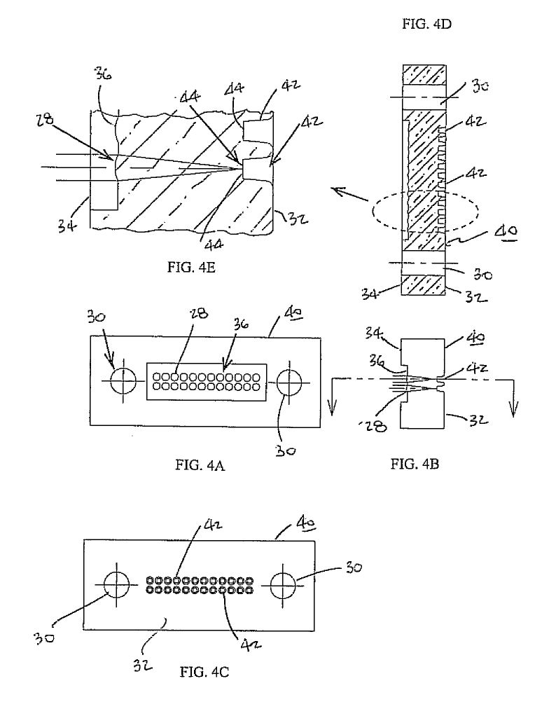

As shown in FIGS. 3A-3D, which represents essentially different views of the assembly of the ferrule 10 and of the housing 26 for the microlens array 28, this illustrates the front optical fiber ends 20 in alignment with an optical transmissive path leading to each respective microlens of the array of microlenses 28 formed in the opposite recessed surface 34 in the microlens-containing housing. The leading optical fiber ends 20 are cleaved and may be manufactured by means of laser processing so as to be in accurate alignment with the microlenses 28 in the opposite end of the surface 34 in the housing 26.

Although the foregoing structure and assembly of the ferrule containing the optical fibers in alignment with the array of microlenses is essentially satisfactory, this necessitates a highly accurate machining or manufacturing process for forming the array of holes 18 interiorly of the ferrule 10 so as to afford a precise alignment with the respective array of microlenses. Accordingly, any encountered minor offset of the alignment holes in, respectively, the ferrule 10 and the housing 26 containing the microlenses, and any slight misalignment of the holes 18 containing the leading ends of the optical fibers 16 will adversely affect the effectiveness of the microlenses in their respective housing, and provide for either distorted or non-existent optical projections or paths.

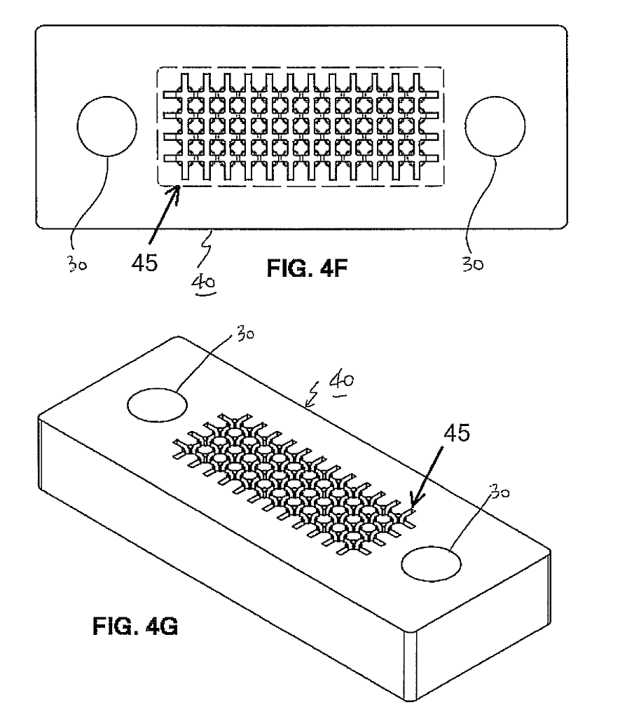

Accordingly, in order to obviate the foregoing disadvantages, pursuant to the invention as illustrated particularly in FIGS. 4A-4E of the drawings, wherein similar or identical components are identified by the same reference numerals, a housing 40 containing an array of microlenses 28, similar to the structure shown in 3A through 3D of the drawings, incorporates in the surface 32 facing towards a ferrule 10 with which it is to be mated, incorporates an array of recessed blind apertures 42 essentially tapering down in size towards the bottom 44, or towards the top 44, thereof, essentially providing the guiding features as recesses spaced in conformance with the microlens arrays. Each of the openings forming the blind holes 42 is optically aligned with a respective one of the microlenses 28 while also essentially in number correlating with the optical fibers 16 which extend from the leading or front end surface of the ferrule 10. For the remainder, the housing structure which contains the array of microlenses, is analogous to that shown in FIGS. 3A-3D of the drawings, the parts of which are identical or similar thereto are being identified by the same reference numerals. It is understood that the guide holes 42 can take on several different shapes. For example the bottom of the guide hole may be concave or convex. The guide holes could be triangular, square, pentagonal, or beyond. As shown in FIGS. 4F-4G, venting slots 45 could intersect the guide holes in order to provide a channel for adhesive to escape when the fibers are inserted.

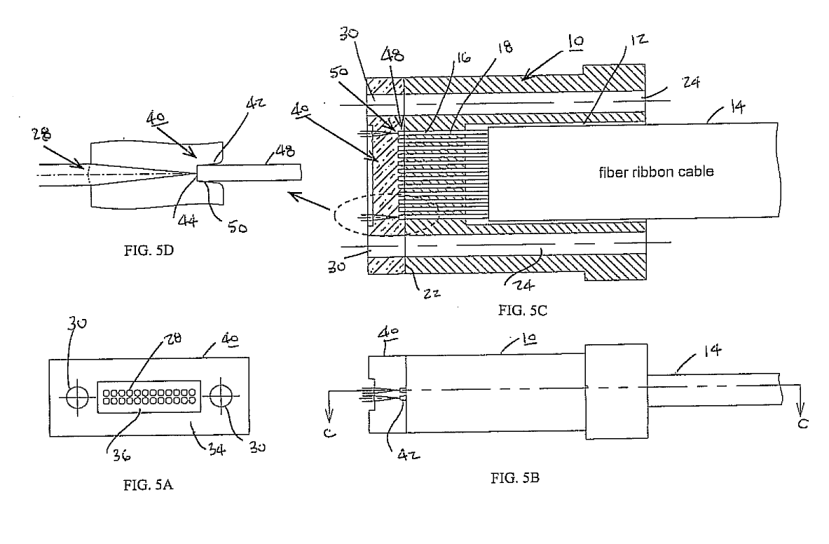

Similarly, as illustrated in FIGS. 5A-5D of the drawings, wherein the ferrule 10 of the invention is essentially analogous to the ferrule shown in FIGS. 1A-1C, however in this instance, the openings or holes 18 which contain and guide each respective one of the leading end portions 48 of the optical fibers 16 extending forwardly from the fiber ribbon cable 19, may be somewhat larger in size than the outside diameters of each respective optical fiber; in effect, providing for a looser tolerance therewith.

In connection with the foregoing, in this instance, the forward or front ends 48 of each of the optical fibers 16 extend forwardly so as to project from the front plane or surface 22 of the ferrule 10 so as to be each in general alignment with a respective, associated one of a recesses or blind holes 42 in the housing 26 containing the microlens array 28, and as illustrated in FIG. 5D of the drawings on a larger scale, each of the projecting front ends 48 of the optical fibers 16, whereby the fiber ends may be cleaved through laser trimming, has the leading end 50 received within a guiding feature, i.e., blind hole 42 formed in the surface 32 of the housing for the microlens array. The fibers may be held in place using an optically transparent adhesive. Consequently, any slight offset of the leading ends 50 of the respective optical fibers 16 which may be caused by the slightly larger dimensioned holes 18 in which they are guided in the ferrule 10 and which afford looser manufacturing tolerances will be compensated for in that the leading end 50 of each respective optical fiber 16 is guided into the respective therewith associated guiding feature or blind hole 42 to contact the bottom 44 formed in the housing for the microlens array, thereby ensuring a correct alignment and resulting optical communication between the optical fibers 16 and therewith associated microlenses 28. This facilitated relaxing in the tolerances in forming the guide holes 18 within the front portion of the ferrule 10 receiving the optical fibers 16, will enable the manufacturing costs of the ferrule to be considerably reduced, rendering the structure highly economical, particularly in the contemplated large scale usage thereof.

Although the lens housing 40 and ferrule 10 in FIGS. 5A-5D are shown as separate pieces it is understood that these may be molded as a single piece, thereby further reducing costs.

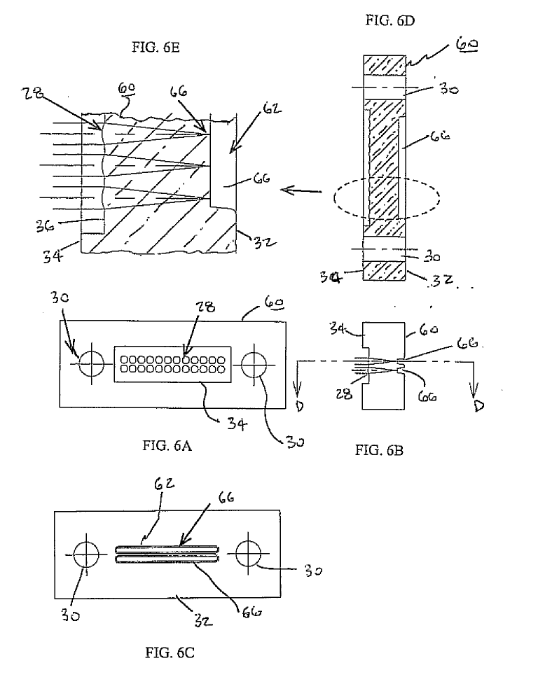

As shown in FIGS. 6A-6E, there is illustrated a modification of the housing 60 containing an array of microlenses 28, as shown in FIGS. 4A-4G of the drawings, whereby in this instance, the guiding feature 62 formed in the surface 32 of the housing 60 which is adapted to mate with the front end surface of a ferrule rather than containing individual blind holes 42 into which the leading ends of the respective optical fibers are to be introduced, guiding features comprise at least a pair or plurality of superimposed elongated slots 66 in close parallel spacing, which extend recessed into the surface 32 of the microlens array-containing housing 60 in optical alignment with the array of microlenses.

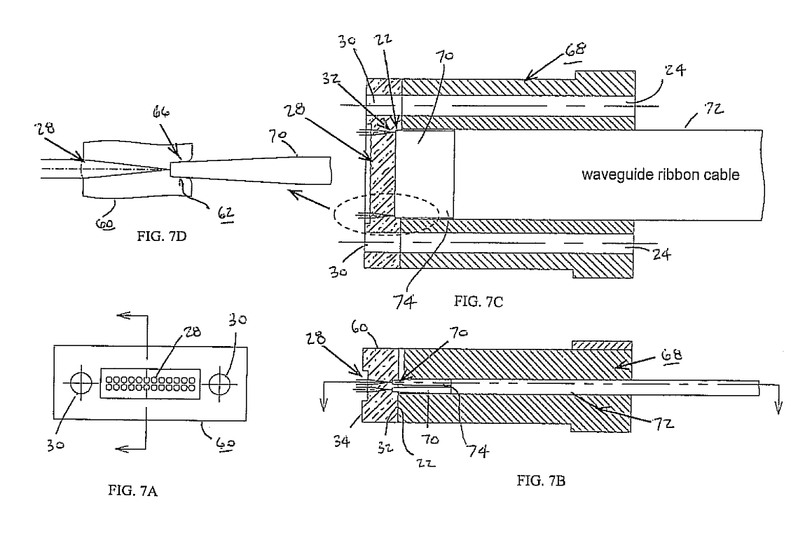

As illustrated in FIGS. 7A-7D of the drawings, in lieu of a optical fiber ribbon cable 14 as heretofore, in this instance, there are present superimposed special optical waveguide ends 70, generally a flat surface nature extending from a waveguide ribbon cable 72, and wherein the ferrule 68 rather than possessing plurality of guiding holes 18 for optical fibers 16, provides for a single large slot or multiple smaller slots 74 formed therein, through which the outwardly projecting leading end 70 of each of the waveguides is guided within loose tolerances and is insertable into a therewith associated slot 66 formed in the mating surface 32 of the housing containing the microlens array 28. Consequently, this will also enable leading openings to be formed in the ferrule at looser tolerances. Each of the projecting leading waveguide ends 70 may be laser trimmed in a simple and inexpensive manner, so as to be guidingly and accurately insertable into the correspondingly configured slots formed 66 in the mating surface of the housing containing the array of microlenses, in optical alignment with the latter. This laser trimming is performed accurately with respect the waveguide cores within each waveguide ribbon cable 70. Conversely there may also be other techniques than laser trimming for accurately sectioning the waveguide ribbon cable with respect to the waveguide cores such as mechanical stamping or chemical etching. For example, a waveguide ribbon cable 70 with an overall thickness of 200 microns may contain 12 or more individual cores (through which light travels, similar to optical fiber cores) that may be 5 to 50+ microns in size. These cores may be positioned on a 250 micron pitch. In this example the outer most cores would be spaced apart by 2,750 microns. The waveguide ribbon cable 70 could be accurately trimmed to a width of 3,000+ microns with care taken to ensure the waveguide cores are precisely centered (side to side) within the waveguide ribbon cable 70.

It is noted that guiding features 22 in housing 60 are used to accurately position (side to side) the waveguide ribbon cable 70 with respect to the lens array 28. Other means may be used to accurately position the waveguide side to side. For example, it is possible to use laser, mechanical stamping, chemical etching or other means to drill holes or notches in the waveguide ribbon cable thereby providing features that are accurately positioned horizontally with respect to the waveguide cores. These horizontal alignment features would then reference and engage corresponding features in the housing 60 or ferrule 68 in order to accurately position the waveguide ribbon cable 70 horizontally with respect the tens array 28.

It is noted that guiding features 66 and 62 in housing 60 are used to accurately position (vertically: up/down) the waveguide ribbon cable 70 with respect the lens array 28. It is noted that within the waveguide ribbon cable the optical cores are accurately positioned vertically to at least one of the outer surfaces of the waveguide film stack. This surface serves as a primary vertical alignment feature when the waveguide ribbon cable engages the vertical guiding features 66 and 62 in housing 60.

Conversely, if the optical cores are not accurately positioned vertically to at least one of the outer surfaces of the waveguide film stack, then a waveguide trimming operation may be performed by using a laser, mechanical cutter, chemical etch or other means to trim the top or the bottom of the waveguide film stack in order to accurately reference the optical cores to the top or bottom surface of the waveguide film stack.

It is understood that the slot may take on many shapes. For example the slot may be nearly horizontal on the side facing the waveguide reference surface, while the other side of the slot may contain a larger taper, thereby pushing the waveguide ribbon towards the reference surface. The slot may contain side vents to allow the optical adhesive to escape from the slot during assembly.

Although the lens housing 60 and ferrule 68 as shown in FIGS. 7A-7D are shown as separate pieces it is understood that these may be molded as a single piece, thereby further reducing costs.

From the foregoing, it becomes readily apparent that the inventive structures are adapted to reduce manufacturing costs for the ferrules 10, 68 containing either the optical fibers or waveguides by considerable amount through incorporating the inventive guiding features, such as therewith aligned holes 42 or slots 66 for receiving, respectively, the leading or projecting ends of the optical fibers or waveguides emanating from the ferrule.

Moreover, although the foregoing ferrule and housing structure has each been illustrated as being respectively rectangular in nature, showing two rows of microlenses in an array, which will provide for three-dimensional optical fiber or waveguide connections, it is also possible that the ferrule and respectively, the therewith associated housing containing the microlenses, can in cross-section be either square, oval or circular or otherwise configured in nature so as to allow for different configurations in the arrays of optical fibers or waveguides, and in effect, not limited to the configuration disclosed herein.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but to fall within the spirit and scope of the appended claims.

What is claimed is:

1. An arrangement for optically aligning an array of optical fibers with an array of microlenses, comprising:
a housing of a optically transmissive material and containing said array of microlenses having a first surface, said array of microlenses being located in a surface of said housing that is distant from and opposite to said first surface of said housing; and
guide features being formed in said first surface of said housing for receiving therein the projecting end portions of said optical fibers so as to facilitate an accurate optical alignment between each of said optical fibers with respectively one of said microlenses of said arrays.

2. An arrangement as claimed in claim 1, wherein said guide features comprise a plurality of blind holes tapering down in size towards the bottom thereof, each said blind hole having respectively one of said optical fiber ends inserted therein.

3. An arrangement as claimed in claim 2, wherein each of said blind holes is optically aligned with respectively one of said microlenses so as to accurately align the optical fiber end received therein with said therewith associated microlens.

4. An arrangement as claimed in claim 1, wherein said array of optical fibers is numerical equal to the array of microlenses optically aligned therewith.

5. An arrangement as claim in claim 4, wherein said optical fibers and microlenses are arranged in said arrays that are configured to provide for three-dimensional optical alignments.

6. An arrangement as claim in claim 2, wherein each of said blind holes is circular in transverse cross-section and adapted to receive a therewith associated optical fiber end in close-fitting contact.

7. An arrangement including a ferrule containing an optical fiber ribbon cable including said array of optical fibers, said optical fibers each extending through an therewith associated separate passageway in said ferrule and having end portions projecting from a wall surface of said ferrule;
wherein each said separate passageway in said ferrule comprise a hole in cross-section dimensional to have an optical fiber guidingly extending there through at a loose tolerance therewith.

8. An arrangement as claimed in claim 1, wherein said microlens-containing housing is essentially constituted of a transparent plastic material.

9. An arrangement as claimed in claim 1, wherein said microlens-containing housing is essentially constituted of glass.

10. An arrangement as claim in claim 1, wherein the end portions of said optical fibers have mechanically cleaved leading ends.

11. An arrangement as claimed in claim 1, wherein the end portions of the said optical fibers have laser cleaved leading ends.

12. An arrangement as claimed in claim 6 where the housing and ferrule are molded as a single piece.

13. An arrangement for optically aligning a plurality of superimposed waveguide ends with an array of microlenses, comprising:
a housing of an optically transmissive material and containing said array of microlenses having a first surface, said array of microlenses being located in a surface of said housing that is distant from and opposite to said first surface of said housing; and
guide features being formed in said first surface of said housing for receiving thereon the projecting end portions of said waveguides so as to facilitate an accurate optical alignment between each of waveguides with at least one or more of said microlenses in the array of microlenses.

14. An arrangement as claimed in claim 13, wherein said guide features comprise at least two parallel spaced elongate slots formed in said first surface of said housing for receiving therein the projecting end portions of respectively said stacked waveguides so as to facilitate accurate optical alignments thereof with associate microlenses.

15. An arrangement as claimed in claim 13, wherein each of said projecting waveguide end portion is receivable in a respective said elongate slot in close-fitting contact.

16. An arrangement as claim in claim 13, wherein said waveguide end microlenses are arranged to facilitate for three-dimensional optical alignments therebetween.

17. An arrangement including a ferrule containing waveguide ribbon cable having a plurality of essentially flat waveguides in stacked relationship, said waveguides extending from said ribbon cable through at least one elongate aperture so as to have end portions thereof projecting from a wall surface of said ferrule; wherein said waveguides are guided within said ferrule at loose tolerances whereby accurate optical alignment with said microlenses is facilitated by the waveguide and portions being inserted in said guiding features.

18. An arrangement as claimed in claim 13, wherein said microlens-containing housing is essentially constituted of a transparent plastic material

19. An arrangement as claimed in claim 13, wherein said microlens-containing housing is essentially constituted on glass

20. An arrangement as claim in claim 13, wherein said waveguide ends are formed by laser trimming.

21. An arrangement as claimed in claim 17 where the housing and ferrule are molded as a single piece.
